(19) United States
(12) Patent Application Publication
(10) Pub. No.: US 2005/0099404 A1
(43) Pub. Date: May 12, 2005

(54) Maintenance of user interfaces

(76) Inventor: Torkel Hjerpe, Uppsala (SE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/432,490

(22) PCT Filed: Nov. 12, 2001
(86) PCT No.: PCT/SE01/02494

(30) Foreign Application Priority Data
Nov. 22, 2000 (SE) 0004299-4

(51) Int. Cl. G09G 5/00

(52) U.S. Cl. 345/179

(57) ABSTRACT

The present invention relates to a system and a method for supporting the handling of questions and conclusion drawing regarding the question, for designing, maintaining and executing user interfaces toward computers. A dynamic control and checking of questions and conclusions via at least one drawing on a computer screen is accomplished by linking and combining data in question means (QS), computation means (CS), gathering means (ANY) and conclusion means (CONC) with each other. Conclusions are specified either depending on values from both the question means (QS) and conditions/computations from the computation means (CS) or depending only on values from conditions/computations from the computation means (CS). Generated or input values of questions momentarily affect the performance, design and output of the user interface and thereby describe how subsequent questions to a user depend on the answers to previous questions.

### TECHNICAL FIELD

The present invention pertains to a system and a method for supporting dynamic questioning and conclusion drawing regarding the questions in user interfaces towards computers for the purpose of designing, maintaining and executing user interfaces with different components, questions, which influence one another and/or themselves.

### BACKGROUND ART

Development and design of user interfaces, which simplify the management of a computer for a user, are among the most important, and for many application and system developers also among the most difficult, areas within the field of programming. Since application and system developers are often in charge of developing aids for interactivity between user and computer, it is a problem that many of them lack both skill and sufficient means for developing applications within this area.

User interfaces in the form of application software directed towards simplifying computer management are often based on questions, in a wider sense, being asked to computer users. The questions can relate to different things, such as choosing a number, making a choice from a list, answering Yes/No-questions, marking in “checkboxes”, choosing an icon from a panel of tools, etc. The answer to a question can control properties, attributes, of other questions, and the answer to a given question can, for example, result in that another question will not be asked, i.e. it is hidden. Further, possible alternative values, “domains”, can be limited for a question and/or a question can get a new standard value, the default value. Furthermore, the screen positions of certain questions can be changed, depending on the answer/answers of other questions.

The user interface is a dynamic and often a complex system where different components, for example questions, influence each other or even themselves. Certain conclusions, output, are also often to be generated from the answer values of the questions.

The current technology for handling questions dynamically in user interfaces lacks a standard tool, which can be applied on different interfaces. Each interface, where questions influence each other, is with current technology programmed from the beginning at a low level, since a suitable descriptive language/tool is lacking. Whether traditional programming languages, such as C++, or visual languages such as ProGraph, are used all dependencies between questions, variables, must be programmed separately. This is of course a both time-consuming and costly method for developing this type of software.

Graphic tools for system development, for example based on UML (Unified Modeling Language), also do not address the problem of describing the dynamics of user interfaces.

The present invention aims at solving the problems mentioned above by providing a system and a method, which supports and automates dynamic questioning and conclusion drawing regarding the questions in user interfaces towards computers, as evident through characterizing parts in the supplemented independent claims.

The dependent claims furthermore set forth preferred embodiments of the invention.

### SUMMARY OF THE DISCLOSED INVENTION

The present invention aims at providing a system and a method, which support dynamic questioning and conclusion drawing regarding the questions, thereby forming an implement, for example for programming- and system developers, who among other things want to design, maintain and also execute user interfaces towards computers. The system and method, via means for controlling and checking questions and conclusions and through linked functions in drawings on a computer screen, allow specifying the dynamics in such user interfaces.

The parameters, attributes, which can be influenced are constituted of different degrees of graphical visibility, alternative and default values, character positioning and character design. A system of linked and to different degrees mutually dependent functions in one or several drawings thereby enables a programming developer/system developer to continuously modify and determine how graphics, positioning, design and output of subsequent questions should depend on the answers to previous questions in user interfaces that shall act dynamically.

The functions in the drawings will then momentarily, i.e. at every given point of time, specify how user interfaces shall act, how they shall appear and what shall be output.

The system and method are intended to be applied for design, maintenance and execution of user interfaces, where different components, questions, influence one another and/or themselves.

The present invention in this respect sets forth a system for supporting the handling of questions and conclusion drawing regarding the questions for designing, maintaining and executing user interfaces toward computers. The system comprises:
means for dynamic control and checking of questions and conclusions via at least one drawing on a computer screen through the linking of:
question means (QS), which refer to questions to be put to a user;
computation means (CS), for executing computations and/or setting conditions on values retrieved from the question means (QS);
gathering means (ANY), through which a number of question means (QS) are group-interpreted as a disjunction;
conclusion means (CONC), for specifying conclusions depending on values from:
the question means (QS) and conditions/computations from the computation means (CS); or solely conditions/computations from the computation means (CS); and
wherein generated or input values of questions momentarily affect the performance, design and output of the user interface and thereby describe how subsequent questions to the user depend on the answers to previous questions.

In embodiments of the system according to the present invention, an interpreter can interpret a drawing in order to handle the questions and conclusions dynamically in the user interface. The interpreter can be an interpreting means or a compiler, which can generate programming code in a specific programming language. Furthermore, the generated programming code can implement the functionality in the drawing/drawings.

In other embodiments of the system according to the present invention, the question means (QS) can be provided with one or several attributes having associated initial values to each of the utilized attributes. The attributes can, for example, be visibility, alternative values, default values, position, color, shape, sound and duration. The drawings can retrieve values to the question means (QS) from a database or an Excel sheet, and each question can have an identifier, for example a string of text.

In one embodiment of the system according to the present invention, conditions in a computation means (CS) shall evaluate to a value, TRUE, in order for an interpretation to proceed from the computation means (CS).

Furthermore, the present invention denotes a method for supporting the handling of questions and conclusion drawing regarding the questions, for designing, maintaining and executing user interfaces toward computers. A dynamic control and checking of questions and conclusions via at least one drawing on a computer screen is accomplished by linking and combining data in question means (QS), computation means (CS), gathering means (ANY) and conclusion means (CONC) with each other for the purpose of specifying conclusions either dependent on values from the question means (QS) and conditions/computations from the computation means or dependent only on values from conditions/computations from the computation means (CS). Generated or input values of questions, momentarily affect the performance, design and output of the user interface and thereby describe how subsequent questions to the user depend on the answers to previous questions.

In embodiments of the method according to the present invention, an interpreter can interpret a drawing in order to handle the questions and conclusions dynamically in the user interface. The interpreter can be an interpreting means or a compiler, which can generate programming code in a specific programming language. Furthermore, the generated programming code can implement the functionality in the drawing/drawings.

In other embodiments of the method according to the present invention, the question means (QS) can be provided with one or several attributes having associated initial values to each of the utilized attributes. The attributes can, for example, be visibility, alternative values, default values, position, color, shape, sound and duration. The drawings can retrieve values to the question means (QS) from a database or an Excel sheet, and each question can have an identifier, for example a string of text.

In one embodiment of the method according to the present invention, conditions in a computation means (CS) shall evaluate to a value, TRUE, in order for an interpretation to proceed from the computation means (CS).

The question means (QS) can be constituted of question images or the like.

The computation means (CS) can be constituted of computation images or the like.

The gathering means (ANY) can be constituted of gathering images or the like.

The conclusion means (CONC) can be constituted of conclusion images or the like.

### BRIEF DESCRIPTION OF THE DRAWINGS

Henceforth reference is had to the attached images for a better understanding of the present invention and its examples and embodiments, wherein:

FIG. 1 illustrates schematically how a user's answers to questions put in a user interface in a computer momentarily affects the performance, design and output of the user interface, according to one embodiment of a method of the present invention.

FIG. 2 illustrates a drawing with an image 600 describing input to question images QS from computation images CS, according to one embodiment of a method of the present invention.

FIG. 3 illustrates a drawing with an image 700 describing input to question images QS from computation images CS, according to one embodiment of a method of the present invention.

FIG. 4 illustrates a drawing with an image 800, which describes utilization of gathering images ANY, according to one embodiment of a method of the present invention.

FIG. 5 illustrates a drawing with an image 900, which describes utilization of conclusion images CONC, according to one embodiment of a method of the present invention.

### DETAILED DESCRIPTION OF PREFERRED EMBODIMENTS

A detailed description of a system and preferred embodiments of a method for supporting the handling of questions and conclusion drawing regarding the questions for designing, maintaining and executing user interfaces toward computers according to the present invention, follows with reference to the supplemented drawings.

The system and method according to the present invention describe a graphic device for constructing and defining interpretation of drawings on computer screens, in order to dynamically define different parameters, attributes, such as visibility, alternative values (domain), standard values (default) and other properties, for questions that can be put to a user through a user interface.

Such a drawing is built up by one or several images consisting of mutually linked images, such as question images, computation images, gathering images and conclusion images, which describe different functions of a drawing. In the drawing/drawings, the parameters/attributes, e.g. visibility, alternative values, “domain”, standard values, “defaults”, and other properties, are specified dependent of the current value of the answers to other questions, which can be starting values, values from interaction with users or values specified by the drawing/drawings itself. Conclusions that depend on the answer values of questions are also specified.

At each point of time in the dynamical interface during user interaction, the drawing can be interpreted automatically in order for current values, for example for, visibility, alternative values, i.e. domain, standard values, i.e. defaults, position and design to be determined in the user interface for each question. Two computerized solutions to be utilized for the drawing/drawings to dynamically control the questions in the user interface and the conclusion drawing. One of these is an interpreter, which interprets the actual drawing, puts questions to the user, updates the questions and generates conclusions. The other technical solution is to employ the drawing for generating or compiling code in a specific programming language. The outcome, result, will then be a piece of software that implements the actual functionality in the drawing/drawings. A drawing is thus either interpreted by an interpreting means or by a compiler, which among other things can decide in what order the images in the drawing shall be interpreted and avoid circular setting of standard values, defaults.

The technique for designing both an interpreting means and a compiler is in itself well known.

Drawings on a computer screen consist, as mentioned above, of a number of images built up by different images, or shapes, which can be linked mutually and which describe functions in the drawing.

A question means or Question Shape means QS can have one or several of the following attributes with initial values for each of the utilized attributes: standard value, “default”, possible alternative values, “domain”, value for visibility, “visibility”, which can be either “visible” (visible and changeable for the user), “dimmed” i.e. visible but not changeable for the user or “hidden” i.e. hidden and not changeable for the user, and other attributes, “properties” as for example position, design (such as color or shape), sound and duration.

Drawings can retrieve values to a number of question means QS, for example, from a database or an Excel sheet, wherein each question has an identifier, for instance a string of text, and also has initial values for the attributes to be utilized. Alternatively, this information or part of it can be provided directly in the drawing. Interpretation of a drawing, preferably by means of an interpreting means or a compiler, at a specific point of time provides current values on all the question means QS, on condition that the calculations in the drawing terminate.

The computation means or “Computation Shape means” CS, in turn puts conditions on values retrieved from a number of question means QS and/or performs calculations, computations, most often based on values from a number of question means QS. The conditions in a computation means CS shall evaluate to a truth-value, TRUE, for the interpretation to proceed from the means. Condition-computations and other computations are specified in e.g. a programming language or in another formalism, which can be interpreted automatically.

The gathering means or “ANY shape means” ANY collects values from a number of computation means CS to a disjunction, meaning that the value from at least one of these computation means CS has to evaluate to a truth-value, TRUE, for the interpretation to continue.

The conclusion means or “Conclusion Shape means” CONC specifies conclusions, which wholly or partly depend on values from a number of question means QS. Interpretation of a drawing at a specific point of time provides current values on all the conclusion means CONC, on condition that the comprised calculations, computations, in the drawing terminate.

Graphic links, for instance arrows, are utilized to bind together question means QS, computation means CS, gathering means ANY and conclusion means CONC into one or several images, which together form a drawing, for example on a computer screen.

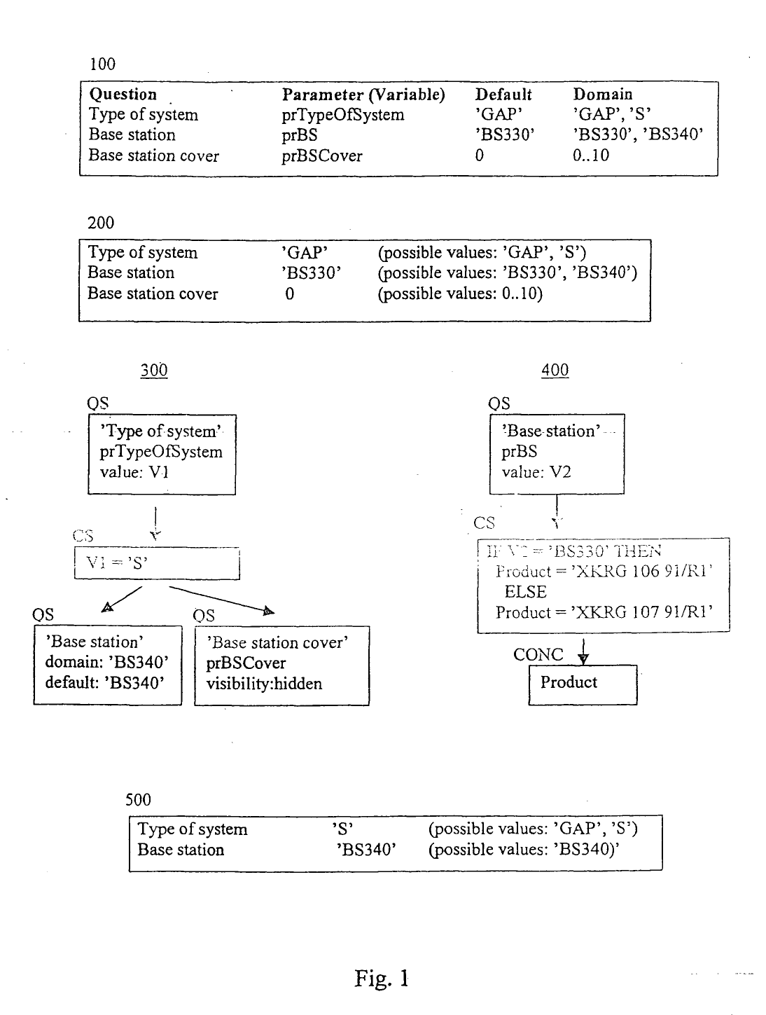

In FIG. 1 is illustrated how a user's answers to questions put in a user interface 200 in a computer momentarily affects the performance, design and output of the user interface 200. A user will here choose “type of system”, “base station” and possibly a “Cover” in the user interface 200. Base data 100 comprises data about the questions which are to be put to the user, which parameters that can be chosen, standard values, “default”, for the parameters and alternative values or domain values, “domain”, for the parameters. The questions “Type of system”, “Base station” and “Base station cover” are visualized in a left column of the user interface 20, at a specific point of time T0.

In the middle column, the standard values, “default, for the questions that are shown in the left column are set to “GAP”, BS330”, “0”, but these can be re-chosen by the user to optional values from the right column, describing alternative values, “domain”.

The right column shows which alternative values that can be put in the middle column on each question in accordance to the left column. For the question “Type of system”, “default” is at T0 set to “GAP”, we assume that the user at time T1 instead answers and sets the value to “S”. The images 300, 400 with mutually linked question means QS, computation means CS and conclusion means CONC will, based on this answer, calculate and possibly set new values on other questions or perhaps even hide some questions.

In this case, the images 300, 400, specify new current values in the user interface 500, which thus receives a new design at the point of time T1 by means of the question “Type of system” getting a new standard value “S” and the same domain values “GAP” and “S” as of the point of time T0. “Base station” receives the new standard value “BS340” and only the new domain value “BS340”, which means that here, the alternative domain value “BS330”, has been removed. The final question, “Base station cover”, has also been completely hidden to the user, who thereby at the point of time T1 cannot set a new value to this question. In the one image, a conclusion is also generated in the form of a product that, depending on the new standard values is chosen to XKRG 107 91/R1 and is output.

From base data 100, a drawing consisting of two images 300, 400 with linked means QS, CS and CONC and a user choice, “GAP” was changed to “S” on the question, “Type of system”, the following has occurred: One question has been hidden, a new standard value, “default” has been set, a domain has been changed and the product “XKRG107 91/R1 has been generated.

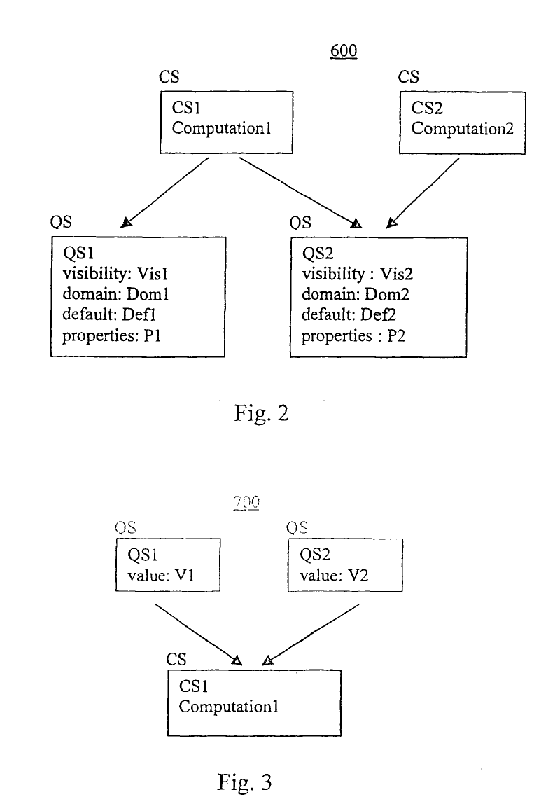

In FIG. 2, an example of a drawing is shown, with an image 600 describing input to question images QS from computation images CS. A question means QS receives input from one or several computation means CS. A computation means CS provides input to one or several question means QS. The outcome, result, is changed values for one or several of the attributes visibility (“visibility”), domain (“domain”), standard value (“default”) and properties (“properties”). All conditions in a computation means CS that proceed to a question means QS must evaluate to a truth-value, TRUE, for the interpretation to continue and attributes are changed in this question means QS.

In FIG. 3, an example of a drawing with an image 700 describing input to computation images CS is shown. A computation means CS receives input from one or several question means QS. Values V from the question means QS are transferred to the computation means CS and these values can be included in the conditions/computations being there performed. For instance can be tested that V1 has a certain value, or all values V can be added together.

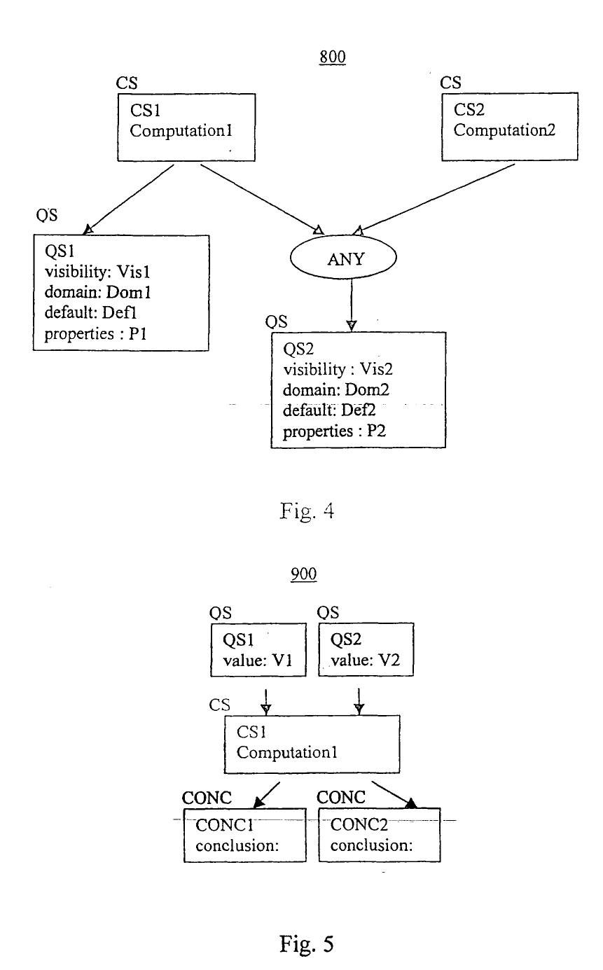

FIG. 4 shows an example of a drawing with an image 800, which describes utilization of gathering means ANY. A gathering means ANY is utilized to bind together a number of computation means CS to a disjunction for enabling transformation from sentence, or clause logic AND to OR, which means that it is sufficient that one of the computation means CS comprised in the gathering means evaluate to IRUE for the attributes visibility (“visibility”), domain (“domain”), standard value (“default”) and properties (“properties”) of the question means QS towards which the gathering means ANY points to be changed. A gathering means ANY can point towards, i.e. provide input to, one or several question means QS.

FIG. 5 illustrates an example of a drawing with an image 900, which describes utilization of conclusion images CONC. A conclusion means CONC is utilized for specifying which conclusions shall follow from the values of question means QS and conditions/computations in computation means CS. For instance, it can be products, which shall be ordered depending on the values of question means QS and rules in the computation means CS. The rules for utilization of the conclusion means CONC are the same as for the question means QS when the attributes visibility (“visibility”), domain (“domain”), standard value (“default”) and properties (“properties”) are defined.

The means mentioned in the present description can be software means, hardware means or a combination of both, known to the skilled person.

The present invention has been described with non-limiting examples and embodiments. The attached set of claims describes all possible embodiments for a person skilled in the art.

1. A system for supporting the handling of questions and conclusion drawing regarding the questions for designing, maintaining and executing user interfaces toward computers,
comprising:
means for dynamic control and checking of questions and conclusions via at least one drawing on a computer screen through the linking of:
question means (QS), which refer to questions to be put to a user;
computation means (CS), for executing computations and/or setting conditions on values retrieved from the question means (QS);
gathering means (ANY), through which a number of question means (QS) are group-interpreted as a disjunction;
conclusion means (CONC), for specifying conclusions depending on values from
the question means (QS) and conditions/computations from the computation means solely conditions/computations from the computation means (CS); and
wherein generated or input values of questions momentarily affect the performance, design and output of the user interface and thereby describe how subsequent questions to the user depend on the answers to previous questions.

2. A system according to claim 1, characterized in that an interpreter interprets the drawing in order to handle the questions and conclusions dynamically in the user interface.

3. A system according to claim 2, characterized in that the interpreter is an interpreting means or a compiler, which can generate programming code in a specific programming language.

4. A system according to claim 3, characterized in that the generated programming code implements the functionality in the drawing/drawings.

5. A system according to claim 1, characterized in that the question means (QS) are provided with one or several attributes having associated initial values to each of the utilized attributes.

6. A system according to claim 5, characterized in that the attributes are visibility, alternative values, default values, position, color, shape, sound and duration.

7. A system according to claim 1, characterized in that the drawings retrieve values to the question means (QS) from a database or an Excel sheet and wherein each question has an identifier, for instance a string of text.

8. A system according to claim 1, characterized in that conditions in the computation means (CS) must evaluate to a truth-value, TRUE, in order for an interpretation to proceed from the computation means (CS).

9. A method for supporting the handling of questions and conclusion drawing regarding the questions, for designing, maintaining and executing user interfaces toward computers, characterized in that a dynamic control and checking of questions and conclusions via at least one drawing on a computer screen is accomplished, by linking and combining data in question means (QS), computation means (CS), gathering means (ANY) and conclusion means (CONC) with each other for the purpose of specifying conclusions either dependent on values from the question means (QS) and conditions/computations from the computation means (CS) or dependent only on values from conditions/computations from the computation means (CS), and wherein generated or input values of questions momentarily affect the performance, design and output of a user interface and thereby describe how subsequent questions to a user depend on the answers to previous questions.

10. A method according to claim 9, characterized in that an interpreter interprets at least one drawing in order to handle the questions and conclusions dynamically in the user interface.

11. A method according to claim 10, characterized in that the interpreter is an interpreting means or a compiler, which can generate programming code in a specific programming language.

12. A method according to claim 11, characterized in that the generated programming code implements the functionality in at least one drawing.

13. A method according to claim 9, characterized in that the question means (QS) is provided with one or several attributes having associated initial values to each utilized attribute.

14. A method according to claim 13, characterized in that attributes include visibility, alternative values, default values, position, color, shape, sound and duration.

15. A method according to claims 9, characterized in that the drawings retrieve values to the question means (QS) from a database or an Excel sheet, wherein each question has an identifier, for instance a string of text.

16. A method according to claim 9, characterized in that conditions in the computation means (CS) must evaluate a truth-value, TRUE, in order for an interpretation to proceed from the computation means (CS).

17. A system according to claim 4, characterized in that the question means (QS) are provided with one or several attributes having associated initial values to each of the utilized attributes.

18. A system according to claim 6, characterized in that the drawings retrieve values to the question means (QS) from a database or an Excel sheet and wherein each question has an identifier, for instance a string of text.

19. A method according to claim 12, characterized in that the question means (QS) is provided with one or several attributes having associated initial values to each utilized attribute.

20. A method according to claims 14, characterized in that the drawings retrieve values to the question means (QS) from a database or an Excel sheet, wherein each question has an identifier, for instance a string of text.
